(19) United States
(12) Patent Application Publication
(10) Pub. No.: US 2018/0104826 A1
(43) Pub. Date: Apr. 19, 2018

(54) MACHINING DEVICE

(71) Applicant: Nachi-Fujikoshi Corp., Toyama-shi (JP)

(72) Inventor: Akira Kunisaki, Toyama-shi (JP)

(21) Appl. No.: 15/726,966

(22) Filed: Oct. 6, 2017

(30) Foreign Application Priority Data
Oct. 14, 2016 (JP) 2016-202176

(51) Int. Cl. B25J 15/00; B25J 9/00

(52) U.S. Cl. CPC B25J 15/009; B25J 9/0096; B25J 15/0095

(57) ABSTRACT

A machining device includes a manipulator, a base portion, and a spindle. The manipulator includes a hand device that grips a workpiece. The spindle is controlled to selectively proceed and retreat with respect to the base portion. The hand device has a workpiece gripping portion and a bottom portion, which is located on the side opposite to the workpiece gripping portion. The base portion and the bottom portion of the hand device have a positioning structure for determining the positions thereof with respect to each other.

### BACKGROUND OF THE INVENTION

The present invention relates to a machining device that includes an automatic workpiece positioning-holding mechanism for machining such as drilling, reaming, tapping, spot facing, and boring.

Typically, a drilling machine is used as a machine tool for performing drilling, reaming, tapping, or the like.

Such machining using a drilling machine involves an operation for holding and positioning a workpiece. To improve the efficiency of such operation, a system is used that combines an industrial robot such as a handling robot with the drilling machine.

In this case, in a robotic arm that grips a workpiece, primary reaction force is produced with respect to the force acting in the feeding direction of a tool such as a drill and secondary reaction force is generated due to the balance of rotation of the tool.

Specifically, the secondary reaction force is produced perpendicularly with respect to the primary reaction force.

To move and position a workpiece, articulated robotic arms must be employed. The arms and joints need to be of sufficient strength and rigidity to tolerate the aforementioned primary and secondary reaction forces, this enlarges the size of the system.

Japanese Laid-Open Patent Publication No. 2001-277066 discloses a technique in which, to restrict displacement of a workpiece holding portion of a robot caused by machining reaction force during milling, a locator pin projected from a table in the x-axis direction is engaged with a locator hole formed in a workpiece holding surface of the robot.

However, while being capable of tolerating reacting force in the revolving direction of a milling cutter, the engagement structure disclosed in the aforementioned document cannot sufficiently restrict displacement caused by the primary reaction force in the feeding direction of a tool such as a drill.

Japanese Laid-Open Patent Publication No. 2010-076020 discloses a technique in which a workpiece is positioned by fitting a pin arranged in a component reference jig into a hole formed in a supporting jig. However, while being capable of exerting an effect of restricting a reaction force in a certain direction, the technique cannot comprehensively restrict displacement caused by the primary reaction force in the feeding direction of a drill or the like and the secondary reaction force that acts perpendicularly to the primary reaction force.

### SUMMARY OF THE INVENTION

Accordingly, it is an objective of the present invention to provide a machining device capable of comprehensively restricting displacement caused by the primary reaction force produced in a feeding direction of a tool and the secondary reaction force produced because of the balance of the rotation of the tool during machining.

A machining device according to the present invention includes a manipulator including a hand device that grips a workpiece, a base portion, and a spindle that is controlled to selectively proceed and retreat with respect to the base portion. The hand device includes a workpiece gripping portion and a bottom portion that is located on a side opposite to the workpiece gripping portion. The base portion and the bottom portion of the hand device have a positioning structure for determining positions thereof with respect to each other.

The hand device is attached to the distal end of the manipulator and holds the workpiece, which is subjected to machining.

The hand device has the workpiece gripping portion and the bottom portion, which is located on the side opposite to the work gripping portion. The workpiece is attached to the work gripping portion using a clamp or the like. The bottom portion is, for example, placed on the base portion, which is horizontal, or is pressed against the base portion, which has a vertical surface. The bottom portion is to be held in contact with the base portion.

In the present invention, the direction in which the spindle selectively proceeds and retreats is defined as the z-axis direction. Directions in which a base surface of the base portion extends are defined as the x-axis direction and the y-axis direction. In this case, a positioning structure for positioning the base portion and the bottom portion of the hand device with respect to each other is not restricted to any specific structure as long as the structure is aimed for positioning in the x-axis direction and the y-axis direction.

For example, the positioning structure may include a plurality of engagement pins, which are arranged in one of the base portion and the bottom portion of the hand device, and a plurality of engagement holes, which are arranged in the other one of the base portion and the bottom portion of the hand device. The engagement pins are selectively engageable with the engagement holes.

In the present invention, the manipulator is an arm having multiple joints and may construct a machining device together with the spindle and the base portion. However, for example, the manipulator may be an arm of a handling robot, and the spindle may be included in a drilling machine.

In the present invention, the base portion may have a vertical surface, and a direction in which the spindle selectively proceeds and retreats with respect to the vertical surface of the base portion may be a horizontal direction.

In the present invention, the spindle of the drilling machine may be controlled by a control unit of the handling robot synchronously with operation of the handling robot.

In the present invention, the handling robot may have a replacement function for a tool or a tool holder. The drilling machine may be one of a plurality of drilling machines that is arranged in an operating range of the single handling robot with respect to the handling robot.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a diagram showing an example of the configuration of a machining device according to the present invention;

FIG. 2 is an enlarged view showing a hand device and the vicinity of the hand device;

FIG. 3A is a diagram showing the relationship of the positions of a base portion, the hand device, and a tool;

FIG. 3B is a diagram showing an example in which the hand device is moved to position and machine a workpiece;

FIG. 3C is another diagram showing the example in which the hand device is moved to position and machine the workpiece;

FIG. 3D is a diagram showing an example of a clamp structure for the workpiece;

FIG. 4 is a diagram showing an example in which the base portion includes a vertical surface and a feeding device is arranged horizontally;

FIG. 5 is a diagram showing an example in which a handling robot and a drilling machine are synchronously controlled;

FIG. 6 is a diagram showing an example in which the handling robot has replacement function for a tool (a tool holder); and

FIG. 7 is a diagram showing an example in which a plurality of drilling machines is arranged in the vicinity of a single handling robot within an operating range of the handling robot.

### DETAILED DESCRIPTION OF THE PREFERRED EMBODIMENTS

The present invention is characterized in that a drilling machine and a manipulator for holding a workpiece are combined. An example in which a drilling machine and a handling robot are combined will hereafter be described.

As will be described, the present invention may be configured as a system in which a versatile handling robot and a drilling machine are combined.

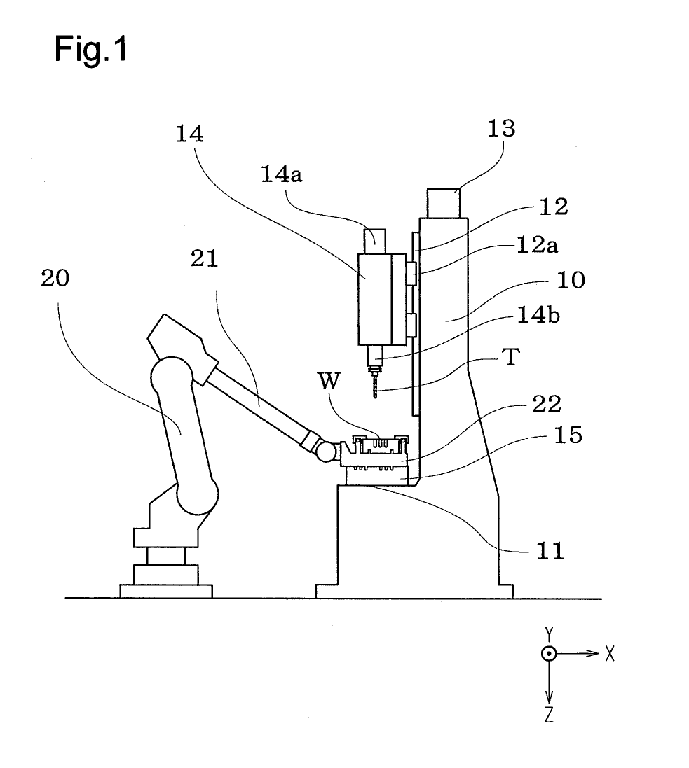

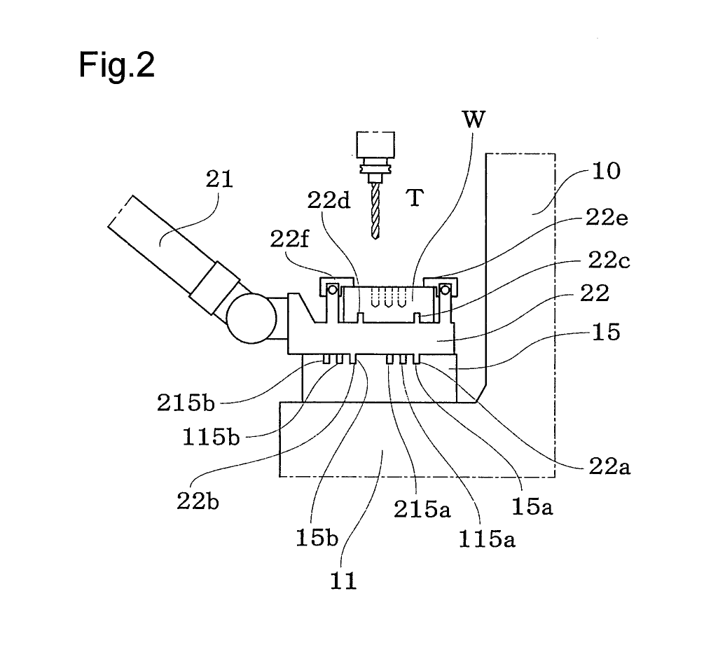

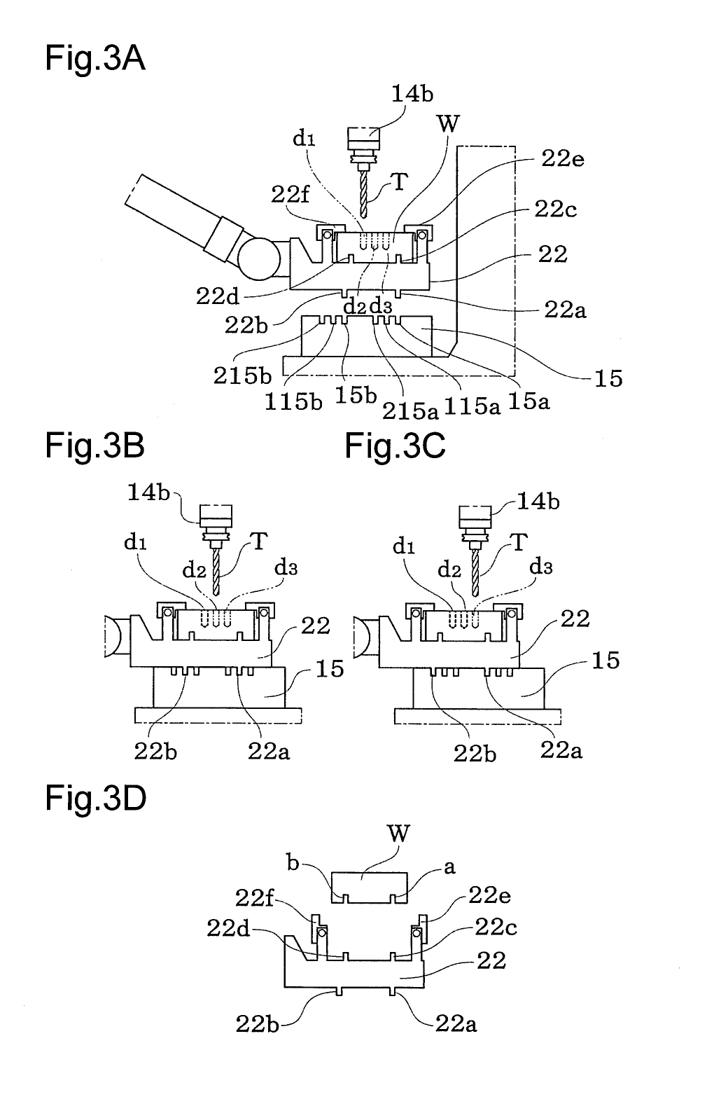

FIG. 1 shows one example of a machining device according to the present invention. FIGS. 2 and 3 are enlarged views each showing a hand device and the vicinity of the hand device.

A base portion 15 is attached to a bed 11 of a drilling machine 10. A hand device 22 is attached to an arm 21 of a handling robot 20. The hand device 22 holds and positions a workpiece W on the base portion 15. In this state, the workpiece W is subjected to machining.

In the present embodiment, the drilling machine 10 is an upright type and has the bed 11, which has a horizontal surface. The drilling machine 10 includes a spindle unit 14, which is controlled to selectively proceed toward and retreat from the bed 11.

The base portion 15 is fixed to the bed 11 in a replaceable manner.

The spindle unit 14 has a main shaft (a spindle) 14b, which chucks a tool, and a spindle motor 14a, which controls rotation of the main shaft 14b.

The spindle unit 14 has an LM guide mechanism, which is configured by a block 12a and a guide rail 12 attached to a column in the vertical direction. A feeding shaft motor 13 controls the position of the spindle unit 14 selectively in the proceeding direction and in the retreating direction.

As long as the spindle unit 14 is controlled by a feeding device to selectively proceed and retreat, the configuration of the spindle unit 14 is not restricted to that of the present embodiment.

With reference to FIG. 1, the feeding direction of the spindle unit (the vertical direction), the depth direction of the bed 11 (the left-right direction as viewed in the drawing), and the width direction of the bed 11 (the direction toward and away from the viewer of the drawing) are defined as a z-axis direction, an x-axis direction, and a y-axis direction, respectively.

The handling robot 20 has the arm 21, which is controlled in an articulated manner. The hand device 22 is attached to the distal end of the arm 21.

The hand device 22 and the vicinity of the hand device 22 are shown in the enlarged views of FIGS. 2 and 3.

The hand device 22 is configured by a workpiece gripping portion, which has clampers 22e, 22f for clamping the workpiece W, and a bottom portion from which positioning pins (22a, 22b) project.

In the present embodiment, an example having two positioning pins projecting from the bottom portion of the hand device 22 is illustrated. However, the number of the positioning pins is not restricted to that of the embodiment as long as positioning is performed in the x-axis direction and the y-axis direction with respect to the base portion 15, which will be described later. Alternatively, the bottom portion of the hand device 22 may have a positioning hole and the base portion may have a positioning pin.

The base portion 15 is fixed to the bed 11 in a manner replaceable in correspondence with the machining specification of the workpiece. In the present embodiment, for illustrative purposes, the base portion 15, which has three sets of positioning holes (15a, 15b), (115a, 115b), and (215a, 215b) in correspondence with three machining portions d₁, d₂, d₃ of the workpiece W, are schematically illustrated. The positioning holes (15a, 15b), (115a, 115b), and (215a, 215b) can selectively be engaged with the corresponding positioning pins (22a, 22b) of the bottom portion of the hand device 22. Although the positioning pins and positioning holes are not restricted to any specific lateral cross-sectional shapes, it is preferable that the positioning pins and holes have circular or rectangular shapes.

As illustrated in FIG. 2, with the positioning pins (22a, 22b) engaged with the positioning holes (15a, 15b), the workpiece W is subjected to machining to form a hole at the machining portion d₁. Subsequently, with reference to FIG. 3A, the hand device 22 is raised to be spaced from the base portion 15. As illustrated in FIG. 3B, the two positioning pins (22a, 22b) of the hand device 22 are then engaged with the subsequent positioning holes (115a, 115b) to start forming a hole at the subsequent machining portion d₂.

FIG. 3C shows a state in which a hole is formed at the third machining portion d₃. In this state, the two positioning pins (22a, 22b) are engaged with the third set of positioning holes (215a, 215b).

In the present embodiment, as illustrated in FIG. 3D, workpiece positioning pins (22c, 22d) are formed in the hand device 22 and engaged with corresponding positioning holes (a, b) of the workpiece W, in such a manner as to facilitate positioning of the workpiece W in the workpiece gripping portion of the hand device 22. However, the structure of such engagement is not restricted to that of the present embodiment, as long as the gripping position of the workpiece W can be fixed.

In the machining device according to the present invention, the hand device is held in contact with the base portion. This allows the base portion to receive the primary reaction force that acts with respect to the feeding direction of the spindle. Meanwhile, the secondary reaction force generated through rotation of the spindle is received by the engagement structure of the bottom portion of the hand device and the base portion.

The size of the manipulator (the handling robot) is thus reduced, and the machining device becomes highly precise and highly productive.

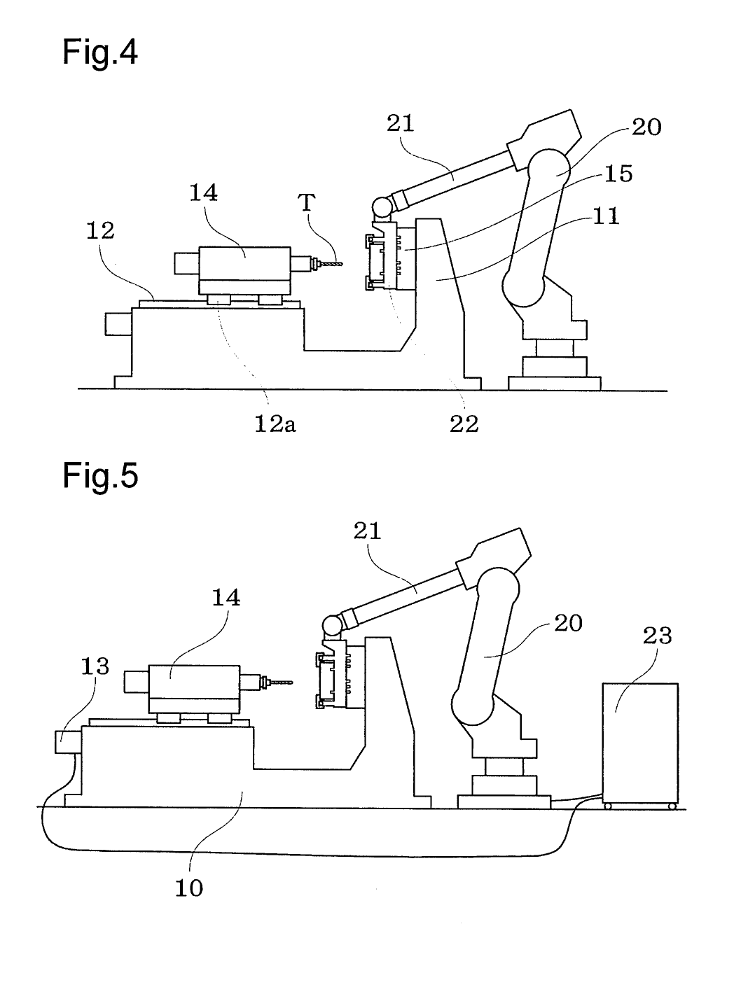

FIG. 4 shows an example of configuration in which the spindle unit 14 is controlled to be fed horizontally and the bed 11 and the base portion 15 are arranged along a vertical plane.

Also in this case, the primary reaction force caused by a tool T is received by the base portion 15 and the secondary reaction force is received by the engagement structure of the bottom portion of the hand device 22 and the base portion 15.

This configuration allows swarf, which is produced at the time of machining, to fall without collecting on the base portion. The swarf is also easily removed.

FIG. 5 shows an example in which a control unit 23 for the handling robot 20 is connected to a control portion of the drilling machine 10, and the control of the arm and the like of the handling robot 20 and the control of the spindle unit 14 are synchronized.

In this manner, the control unit 23 of the handling robot 20 controls feeding of the spindle unit 14. In this case, after machining of the machining portion d₁, for example, the spindle unit 14 is retracted to separate the distal end of the tool T from the corresponding surface of the workpiece W. Meanwhile, the hand device 22 starts to move such that the hand device 22 shifts to the subsequent machining portion d₂ synchronously with the movement of the spindle unit 14.

In a case in which the drilling machine 10 and the handling robot 20 are controlled independently from each other, the hand device 22 starts to move typically after completion of retreat of the spindle unit 14 is confirmed. Compared to this case, the cycle time is decreased in a case in which the drilling machine 10 and the handling robot 20 are synchronously controlled.

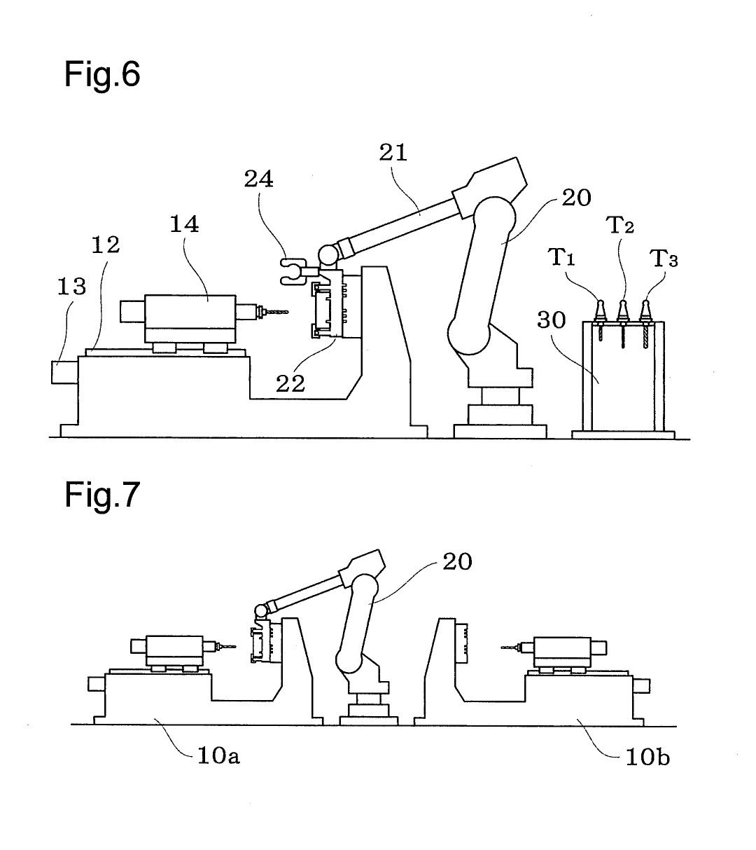

FIG. 6 shows an example in which the arm 21 of the handling robot 20 includes a gripping mechanism 24 for a tool (a tool holder) and various types of tools T₁, T₂, T₃ which are replaceable with respect to the main shaft 14b (see FIG. 1) and are arranged in a tool magazine 30.

This configuration enables tool replacement depending on different hole diameters or in correspondence with spot facing or the like, for example. As a result, at the time of tool replacement, such replacement is automated.

FIG. 7 shows an example in which multiple drilling machines 10a, 10b, etc. are arranged in the vicinity of a single handling robot 20.

This configuration enables continuous execution of different types of machining, such as drilling and tapping, on the workpiece W and improves operating rates of the handling robot 20.

1. A machining device comprising:
a manipulator including a hand device that grips a workpiece;
a base portion; and
a spindle that is controlled to selectively proceed and retreat with respect to the base portion, wherein
the hand device includes
a workpiece gripping portion, and
a bottom portion that is located on a side opposite to the workpiece gripping portion, and
the base portion and the bottom portion of the hand device have a positioning structure for determining positions thereof with respect to each other.

2. The machining device according to claim 1, wherein:
the positioning structure includes a plurality of engagement pins, which are arranged in one of the base portion and the bottom portion of the hand device, and a plurality of engagement holes, which are arranged in the other one of the base portion and the bottom portion of the hand device, and
the engagement pins are selectively engageable with the engagement holes.

3. The machining device according to claim 1, wherein:
the manipulator is an arm of a handling robot, and
the spindle is included in a drilling machine.

4. The machining device according to claim 1, wherein:
the base portion has a vertical surface, and
a direction in which the spindle selectively proceeds and retreats with respect to the vertical surface of the base portion is a horizontal direction.

5. The machining device according to claim 3, wherein the spindle of the drilling machine is controlled by a control unit of the handling robot synchronously with operation of the handling robot.

6. The machining device according to claim 3, wherein the handling robot has a replacement function for a tool or a tool holder.

7. The machining device according to claim 3, wherein the drilling machine is one of a plurality of drilling machines that is arranged in an operating range of the single handling robot with respect to the handling robot.
